(19) United States
(12) Patent Application Publication
(10) Pub. No.: US 2003/0133389 A1
(43) Pub. Date: Jul. 17, 2003

(54) Tray structure for rotation disc devices

(75) Inventor: Kuo-Jen Wang, Chung Li City (TW)

Correspondence Address: BRUCE H. TROXELL, SUITE 1404, 5205 LEESBURG PIKE, FALLS CHURCH, VA, 22041, US

(73) Assignee: Benq Corporation

(21) Appl. No.: 10/335,902

(22) Filed: Jan. 3, 2003

(30) Foreign Application Priority Data
Jan. 11, 2002 (TW) 92100165

(51) Int. Cl. G11B 33/02

(52) U.S. Cl. 369/75.2

(57) ABSTRACT

An improved tray structure for rotation disc devices includes a plurality of rim orifices for improving airflow under a disc sustained upon the tray. The rim orifice located beneath a respective protrusion of the tray is arranged close to the edge of the cavity and provides a predetermined area for airflow. By arranging the predetermined area to minimum 2 times of the area shaded by the protrusion, stability and noise characteristics for operating the disc on the tray can be remarkably improved

### FIELD OF THE PRESENT INVENTION

The present invention relates to a tray structure for rotation disc devices and particularly to a tray structure that has an improved airflow structure for enhancing operation stability and reducing the noise level.

### BACKGROUND OF THE PRESENT INVENTION

Optical disc drives are elementary tools for storing and reading media in computer operations. In application of the disc drives, data storage capacity and reading/writing speed of optical discs are obvious two important indicators about the performance of the disc drives, in which the high speed operation stability of optical discs is the concern of the present invention.

Referring to FIG. 1 for a tray structure of a conventional optical disc drive, the tray 1 as shown has a shallow disk-shaped cavity 10 for supporting an optical disc (not shown in the drawing). The cavity 10 has an outer rim with a plurality of protrusions 11 extending inwards. Each of the protrusions 11 has a predetermined shaded area A. The protrusions 11 serve as bordering limits for holding the optical disc in the cavity 10 in a vertical mounting orientation. As shown in the drawing, in the cavity 10 corresponding to each protrusion 11, there is a rim orifice 12 running through the thickness of the tray 1 and having a predetermined orifice area B. The cavity 10 of the tray 1 further has a driving aperture 15 that provides a predetermined driving section area C to accommodate a rotation motor and a read/write head device (not shown in the drawing) located below the tray 1.

In consideration of increasing the operation speed of the optical disc drive, two topics related to the tray structure 1 shown in the drawing are always concerned. One is the vibration while another is the noise. While part of the noise and vibration problems can be attributed to dynamic characteristics of the optical driving system, another major cause for those concerns is the flow-induced vibration incurred between the optical disc and the tray 1. On study of structure analysis, when an optical disc 20 is disposed on the tray 1 (referring to FIG. 2 for a fragmentary view) for being driven by the motor, there generates an upper airflow 200 above the optical disc 20 and the airflow 200 is distributed in a pattern as shown in the drawing. Also, there is a lower airflow 100 below the optical disc 20 that is distributed in another pattern as shown in the drawing (note: the lower airflow 100 streams around the protrusion 11, shown by broken lines in the drawing). Upon such an arrangement, as the rim orifice 12 presents a relatively small size, the lower airflow 100 does not pass through the rim orifice 12 in a significant volume.

In mechanics, the lower airflow 100 below the optical disc 20 shown in FIG. 2 can generate a local lifting force that can induce a bending force at the edge of the optical disc 20. While the optical disc 20 located on the tray 1 as shown speed up, such a force can increase to some extents that noise and vibration of the optical disc drive may no longer hold the optical disc 20 steadily. As a consequence, the dynamics phenomenon may degrade the performance of operational stability and make the intention of increasing rotation speed (i.e. reading speed) infeasible.

### SUMMARY OF THE PRESENT INVENTION

Accordingly, the primary object of the present invention is to provide a tray structure for rotation disc devices that can present better airflow characteristics around the disc, and thereby operational stability and noise performance of the tray can be improved.

The tray structure for rotation disc devices of the present invention includes a shallow disk-shaped cavity for accommodating an optical disc. The cavity further has an outer rim with a plurality of protrusions extending inwards. Each of the protrusions has a predetermined shaded area. The protrusions serve as upper bordering limits for holding the optical disc in the cavity in vertical mounting orientaion. In the cavity, corresponding to each protrusion, there is a rim orifice running through the thickness of the tray and having a predetermined orifice area as for tooling construction purpose. The present invention characterizes in that the predetermined orifice area of the rim orifice is at least 2 to 15 times of the predetermined shaded area of the protrusion.

According to the present invention, the ratio of radial length to transverse length of the rim orifice is preferably ranged between 1 and 10.

In an embodiment of the present invention, the profile of the rim orifice is preferably bordered on the outer rim of the cavity.

In the present invention, the rim orifice of the tray structure may be an oval-shaped orifice, a radial orifice, or formed in any other proper geometric shapes.

According to one embodiment of the present invention, the cavity of the tray may further include a driving aperture with a predetermined driving section area. The combined area of the predetermined orifice area of all rim orifices is preferably less than 1.5 times of the predetermined driving section area. More preferably, the ratio of the combined area to the driving section area is arranged between 0.5 and 1.0 times.

The foregoing, as well as additional objects, features and advantages of the present invention will be more readily apparent from the following detailed description, which proceeds with reference to the accompanying drawings.

### BRIEF DESCRIPTION OF THE DRAWINGS

FIG. 1 is a schematic view of a conventional tray structure for a rotation tray device in optical disc drive;

FIG. 2 is a fragmentary schematic view of airflow distribution while an optical disc is operated in a tray structure;

FIG. 3 is a fragmentary top view of an embodiment of the present invention showing a rim orifice formed on a tray structure;

FIG. 4 is a fragmentary top view of another embodiment of the present invention showing a rim orifice formed on a tray structure; and

FIG. 5 is a fragmentary schematic view according to the present invention, showing airflow distribution while the tray structure loads an optical disc at operation.

### DESCRIPTION OF THE PREFERRED EMBODIMENTS

The present invention aims at providing improved airflow distribution above and below the tray through altering airflow structure of the tray thereby to increase stability and noise characteristics of the disc-loading tray during operations.

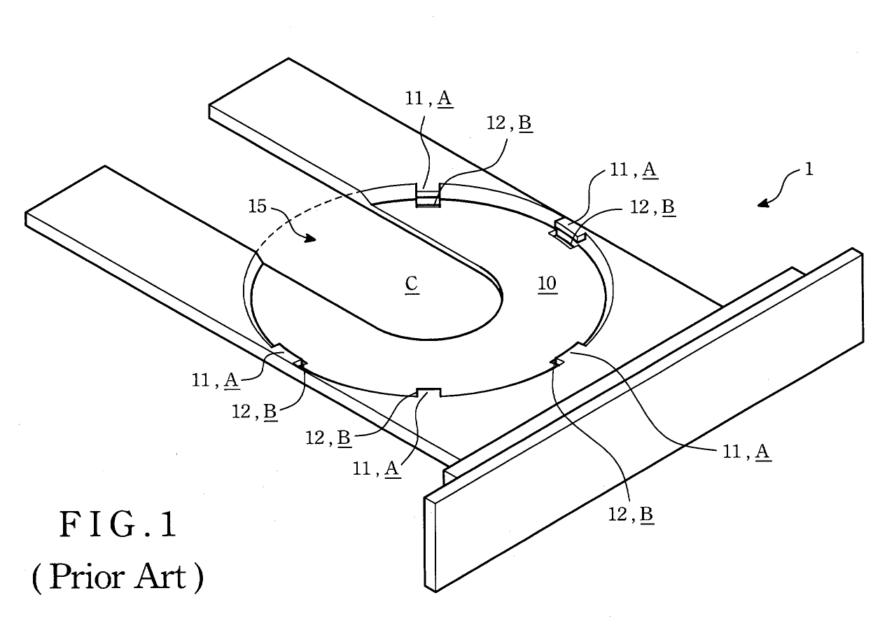

Referring to FIGS. 1, 2 and 3, the tray structure for rotation disc devices according to the present invention, like that of conventional techniques, has a shallow disk-shaped cavity 10 to support an optical disc. The cavity 10 has an outer rim with a plurality of protrusions 11 extending inwards. Each of the protrusions 11 has a predetermined shaded area A. The protrusions 11 serve as bordering limits for holding the optical disc in the cavity 10. In the cavity 10, corresponding to each protrusion 11, there is a rim orifice 12 running through the thickness of the tray 1 and having a predetermined orifice area B. The present invention characterizes in that the predetermined orifice area B of the rim orifice 12 is 2 to 15 times of the predetermined shaded area A of the protrusion 11.

In the present invention, the reason that the predetermined orifice area B of the rim orifice 12 cannot be too much larger than the predetermined shaded area A of the protrusion 11 is to maintain substantially the upward-flowing pattern of the lower airflow 100 through the driving aperture 15

According to the present invention, the ratio of radial length to transverse length (L/H) of the rim orifice 12 on the tray 1 is preferably between 1 and 10 so as to avoid the rim orifice 12 to loose effect of relieving the airflow.

As shown in the drawings, the profile of the rim orifice 12 on the tray 1 is preferably to border the outer rim of the cavity 10 so that difficulty upon modifying the existing tooling can be reduced.

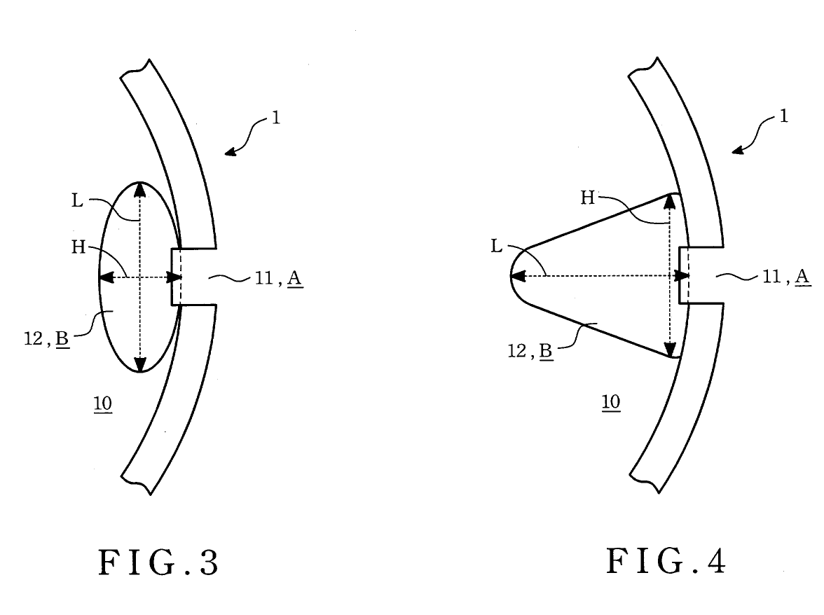

According to the present invention, the profile of the rim orifice 12 on the tray 1 may be an oval-shaped orifice as shown in FIG. 3, or an orifice extending in the radial direction as shown in FIG. 4, or any similar geometric shapes.

In the present invention, in order to take into account the tray 1 having a driving aperture 15 with the driving section area C (as shown in FIG. 1), the sum of orifice area B of all rim orifices 12 is preferably less than 1.5 times of the predetermined driving section area C, and more preferable ratio of the sum of area B to the area C is between 0.5 and 1.0. Upon such an arrangement, airflow of the tray 1 under the disc can be regulated to flow upwards through the driving aperture 15.

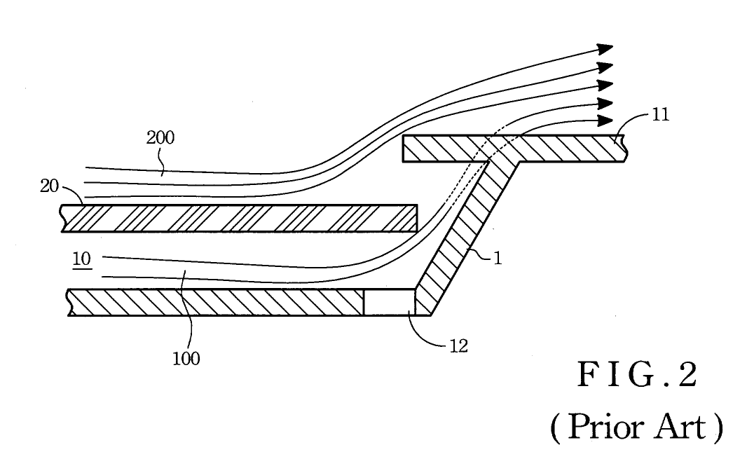

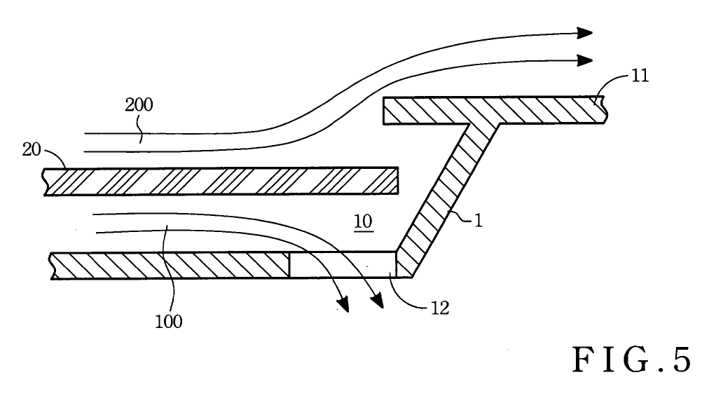

Referring now to FIG. 5, the airflow distribution through the tray structure sustained an optical disc according to the present invention is shown. Comparing with FIG. 2, it shows clearly that the present invention provides a larger size of rim orifice 12 on the tray 1, so that the lower airflow 100 around the edge of the optical disc 20 can be led downwards through the rim orifice 12. Thereby, the upper airflow 200 and the lower airflow 100 together form upward and downward distribution characteristics respectively to directly relieve the forces incurring at the end of the optical disc 20 as described in the FIG. 2. The function and effect achieved by the present invention can thus greatly improve dynamic characteristics of the rotating optical disc 20 in the tray 1.

Experiments and tests performed by the inventor has indicated that the present invention can reduce the noise level of the tray during operation by 2 dBA at least. Such an improvement is significant to the optical disc device industry. Also, it implies that the present invention provides feasibility to increase the operation speed and to improve dynamic characteristics of the disc drivers. Thus, the effort of the present invention to offer optical disc devices a broader application speed ranges is successful.

The present invention can be adapted for any optical disc device such as a computer, a VCD, a DVD, or any other device that has a rotation tray.

While the preferred embodiments of the present invention have been set forth for the purpose of disclosure, modifications of the disclosed embodiment of the present inventions as well as other embodiments thereof may occur to those skilled in the art. Accordingly, the appended claims are intended to cover all embodiments which do not depart from the spirit and scope of the present invention.

What is claimed is:

1. A tray structure for rotation disc devices, comprising a tray which has a disk-shaped cavity to sustain an optical disc, the cavity having an outer rim with a plurality of protrusions extending inwards for bordering the optical disc in the cavity, each of the protrusions having a predetermined shaded area, the cavity having thereof a rim orifice with a predetermined orifice area corresponding to each protrusion, and the predetermined orifice area having a size minimum 2 times of the predetermined shaded area of the protrusion.

2. The tray structure for rotation disc devices of claim 1, wherein said rim orifice has a radial length-to-transverse length ratio between 1 and 10.

3. The tray structure for rotation disc devices of claim 1, wherein said rim orifice has a profile that is bordered on the outer rim of the cavity.

4. The tray structure for rotation disc devices of claim 1, wherein said rim orifice is oval-shaped.

5. The tray structure for rotation disc devices of claim 1, wherein said rim orifice has a shape extending in the radial direction.

6. The tray structure for rotation disc devices of claim 1, wherein said cavity further has a driving aperture with a predetermined driving section area, and a sum of all said predetermined orifice area of said rim orifices is less than 1.5 times of the predetermined driving section area.

7. The tray structure for rotation disc devices of claim 6, wherein said sum of all said predetermined orifice area of said rim orifices is ranged from 0.5 to 1.0 times of said predetermined driving section area.
